(19) United States
(12) Patent Application Publication
(10) Pub. No.: US 2009/0167507 A1
(43) Pub. Date: Jul. 2, 2009

(54) User interface

(75) Inventor: Jani Christian Maenpaa, Helsinki (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/999,841

(22) Filed: Dec. 7, 2007

(51) Int. Cl. G08B 6/00; G06F 3/041

(52) U.S. Cl. 340/407.2; 345/173

(57) ABSTRACT

The invention relates to a user interface of an electronic device. The user interface includes a touch sensitive display panel and an actuator that is arranged to generate a signal that is detectable for a human being. The actuator is arranged to alter a property of the signal as a response to a situation in which an external object is slid on a surface of the touch sensitive display panel. The property of the signal can be, for example, amplitude or frequency of mechanical vibration generated to a housing of the electronic device. The signal represents a feedback to a user of the electronic device and it makes the user interface more illustrative when the touch sensitive display panel is used for controlling a quantity having a continuous nature, e.g. volume of voice generated with a speaker element.

### FIELD OF THE INVENTION

The invention relates to a user interface of an electronic device. The invention further relates to a method and a computer program for controlling an electronic device.

### BACKGROUND

Electronic devices such as mobile communication terminals and palmtop computers are typically equipped with digital devices capable of supporting various services and application functions. As a consequence, designing user interfaces for electronic devices of the kind mentioned above presents unique challenges in view of limited size, a limited number of controls that can be accommodated on such devices, and a need for quick, simple, and intuitive device operation. Especially in conjunction with mobile devices the challenge related to a user interface is exacerbated because such devices are designed to be small, lightweight and easily portable. Consequently, mobile devices typically have limited display panels, keypads, keyboards and/or other input and output devices.

Touch sensitive display panels provide such advantages that a display screen and a keyboard can be integrated together and placing of press buttons of the keyboard can be made freely modifiable. Therefore, considerable savings in the size of a user interface can be achieved. A touch sensitive display panel is inherently suitable for implementing press keys and other control devices with the aid of which discrete control actions, such as pressing a press button, can be directed to an electronic device. On the other hand, using a touch sensitive display panel it is more challenging to implement a control device with the aid of which a quantity having a continuous and non-discrete nature could be adjusted. The quantity having a continuous and non-discrete nature can be, for example, strength of voice generated with a speaker element, brightness of an image shown on a display screen, or a gain of a microphone circuitry.

In a solution according to the prior art a user interface of an electronic device includes both a touch sensitive display panel and mechanical control devices. Display functionalities and at least part of control devices for discrete control actions are implemented with the aid of the touch sensitive display panel. Control actions for adjusting quantities having a continuous nature are carried out using the mechanical control devices. A mechanical control device can be, for example, a mechanical slide or a rotatable knob. The mechanical control devices require room in the user interface, they are vulnerable to impurities, and their placing in the user interface cannot be altered according to different needs in different operational situations of the electronic device.

### SUMMARY

In accordance with a first aspect of the invention a novel user interface is provided. The user interface comprises:
a touch sensitive display panel,
a controller arranged to control an electronic device on the basis of a position of an external object on a surface of the touch sensitive display panel, and
an actuator arranged to generate a signal that is detectable for a human being,
   wherein the actuator is arranged to alter a property of said signal as a response to a situation in which the external object is slid on the surface of the touch sensitive display panel.

The signal that is detectable for a human being represents a feedback to a user of the user interface and it makes the user interface more illustrative when the touch sensitive display panel is used for controlling an electronic device by sliding a finger or some other object on the touch sensitive display panel. In a user interface according to an embodiment of the invention a sliding control device and/or a rotatable control device for controlling quantities having a continuous nature are implemented with the aid of the touch sensitive display panel. The signal that is detectable for a human being can be used for giving to the user a conception of an instantaneous value or strength of the quantity that is being adjusted with the sliding control device or the rotatable control device.

In accordance with a second aspect of the invention a novel method that can be used for controlling an electronic device is provided. The method comprises:
controlling an electronic device on the basis of a position of an external object on a surface of a touch sensitive display panel,
generating a signal that is detectable for a human being, and
altering a property of said signal as a response to a situation in which the external object is slid on the surface of the touch sensitive display panel.

In accordance with a third aspect of the invention a novel electronic device is provided. The electronic device comprises:
a touch sensitive display panel,
a controller arranged to control an electronic device on the basis of a position of an external object on a surface of the touch sensitive display panel, and
an actuator arranged to generate a signal that is detectable for a human being,
   wherein the actuator is arranged to alter a property of said signal as a response to a situation in which the external object is slid on the surface of the touch sensitive display panel.

The electronic device can be, for example, a mobile communication terminal, a palmtop computer, a portable play station, or a measurement instrument such as an oscilloscope. The electronic device can also be a combination of a mobile communication terminal, a palmtop computer, and a portable play station. The electronic device can also be, for example, a domestic appliance or an apparatus for industrial use. A domestic appliance can be e.g. a dishwasher or a washing machine. The apparatus for industrial use can be e.g. a part of control room equipment.

In accordance with a fourth aspect of the invention a novel computer program is provided for making a processor unit to control an electronic device that includes:
a touch sensitive display panel, and
an actuator arranged to generate a signal that is detectable for a human being.

The computer program comprises computer executable instructions for making the processor unit:
to control the electronic device on the basis of a position of an external object on a surface of the touch sensitive display panel, and
to alter a property of said signal as a response to a situation in which the external object is slid on the surface of the touch sensitive display panel.

A computer readable medium can be encoded with the above-mentioned computer executable instructions.

In accordance with a fifth aspect of the invention a novel interface module is provided. The interface module comprises:
a touch sensitive display panel,
a controller capable of controlling an electronic device on the basis of a position of an external object on a surface of the touch sensitive display panel, and
an actuator arranged to generate a signal that is detectable for a human being,
   wherein the actuator is arranged to alter a property of said signal as a response to a situation in which the external object is slid on the surface of the touch sensitive display panel.

A number of embodiments of the invention are described in accompanied dependent claims.

Various embodiments of the invention both as to constructions and to methods of operation, together with additional objects and advantages thereof, will be best understood from the following description of specific embodiments when read in connection with the accompanying drawings.

The embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

The embodiments of the invention that are presented in the sense of examples and their advantages are explained in greater detail below with reference to the accompanying drawings, in which:

FIGS. 1a and 1b show an electronic device comprising a user interface according to an embodiment of the invention,

FIGS. 2a and 2b show an electronic device according to an embodiment of the invention,

FIG. 3 is a flow chart of a method according to an embodiment of the invention, and

FIG. 4 shows an interface module according to an embodiment of the invention.

### DESCRIPTION OF THE EMBODIMENTS

A user interface according to an embodiment of the invention comprises: (i) a touch sensitive display panel, (ii) means for controlling an electronic device on the basis of a position of an external object on a surface of the touch sensitive display panel, (iii) means for generating a signal that is detectable for a human being, and (iv) means for altering a property of said signal as a response to a situation in which the external object is slid on the surface of the touch sensitive display panel.

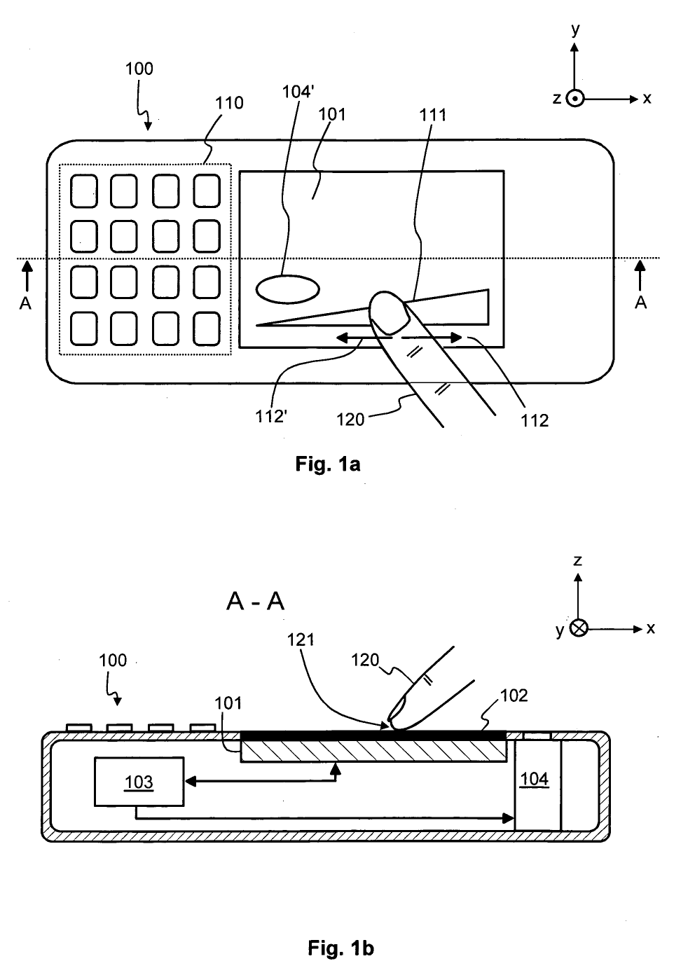

FIG. 1a shows an electronic device 100 comprising a user interface according to an embodiment of the invention. FIG. 1b shows the A-A section view of the electronic device. The user interface of the electronic device comprises a touch sensitive display panel 101 and a controller 103 that is arranged to control the electronic device on the basis of a position of an external object 120 on a surface 102 of the touch sensitive display panel 101. The position of the external object can expressed, for example, with the x- and y-coordinates of a spot 121 where the external object touches the touch sensitive display panel. In the exemplifying situation shown in FIGS. 1a and 1b the external object 120 is a finger of a user of the electronic device 100. The external object 120 could as well be e.g. a pen or a stylus. The user interface comprises an actuator 104 that is arranged to generate a signal that is detectable for a human being, i.e. for the user of the electronic device. The actuator is arranged to alter a property of the signal that can be detected by the user when the external object 120 is slid on the surface 102 of the touch sensitive display panel. The user interface of the electronic device can comprise also a mechanical keyboard 110 and/or other control devices for exchanging information between the electronic device and the user. In the exemplifying situation shown in FIGS. 1a and 1b a sliding control device 111 for controlling a quantity having a continuous nature is implemented with the aid of the touch sensitive display panel 101. The quantity that can be adjusted with the sliding control device can be, for example, strength of voice generated with a speaker element, background brightness of the touch sensitive display panel, or a gain of a microphone circuitry. The above-mentioned quantity can be increased by sliding the external object in the direction of an arrow 112 on the surface of the touch sensitive display panel. The above-mentioned quantity can be decreased by sliding the external object in the direction of an arrow 112′ on the surface of the touch sensitive display panel.

In a user interface according to an embodiment of the invention the actuator 104 is a vibration generator. The vibration generator can be, for example, an electromechanical vibration generator or a piezo-electric vibration generator. The controller 103 is arranged to alter amplitude of mechanical vibration produced with the vibration generator as a response to the situation in which the external object is slid on the surface of the touch sensitive display panel. The amplitude is increased preferably when the external object is slid in the direction of the arrow 112 and the amplitude is decreased preferably when external object is slid in the direction of the arrow 112′. Therefore, the user of the electronic device gets feedback from the electronic device via his/her sense of touch. In a user interface according to another embodiment of the invention, the controller 103 is arranged to alter frequency of mechanical vibration produced with the vibration generator as a response to the situation in which the external object is slid on the surface of the touch sensitive display panel.

In a user interface according to an embodiment of the invention a part 104′ of the touch sensitive display panel 101 is used as the actuator that is arranged to generate a signal that is detectable for a human being, i.e. for the user of the electronic device. The controller 103 is arranged to alter intensity of light shown on the part 104′ of the touch sensitive display panel as a response to the situation in which the external object is slid on the surface of the touch sensitive display panel.

In a user interface according to an embodiment of the invention the actuator 104 is an oscillator capable of generating voice. The controller 103 is arranged to alter amplitude of the voice produced with the oscillator as a response to the situation in which the external object is slid on the surface of the touch sensitive display panel. In a user interface according to another embodiment of the invention, the controller 103 is arranged to alter frequency of the voice produced with the oscillator as a response to the situation in which the external object is slid on the surface of the touch sensitive display panel.

In a user interface according to an embodiment of the invention the actuator 104 is a light source. The controller 103 is arranged to alter intensity of light produced with the light source as a response to the situation in which the external object is slid on the surface of the touch sensitive display panel. In a user interface according to another embodiment of the invention, the controller 103 is arranged to alter color of light produced with the light source as a response to the situation in which the external object is slid on the surface of the touch sensitive display panel.

In a user interface according to an embodiment of the invention the actuator 104 is arranged to alter the property of the signal generated by it as a response to a situation in which the external object is slid along a pre-determined path on the surface of the touch sensitive display panel. The pre-determined path can be defined e.g. by a displayed symbol of a control device 111. The pre-determined path can be a linear path in which case a sliding control device is implemented with the aid of the touch sensitive display surface as shown in FIG. 1b. As an alternative, the pre-determined path can be a circular path in which case a rotatable control device is implemented with the aid of the touch sensitive display surface.

It is also possible that the control device is arranged to alter the property of the signal that is detectable for a human being as a response to a situation in which the external object is slid in a pre-determined direction, e.g. in the x-direction, on the surface of the touch sensitive display panel. In this case, the electronic device can be controlled by sweeping the surface of the touch sensitive display panel starting from an arbitrary point of the touch sensitive display panel. The direction and the length of the sweep can be used for determining the effect of a control action.

An electronic device according to an embodiment of the invention comprises: (i) a touch sensitive display panel, (ii) means for controlling the electronic device on the basis of a position of an external object on a surface of the touch sensitive display panel, (iii) means for generating a signal that is detectable for a human being, and (iv) means for altering a property of said signal as a response to a situation in which the external object is slid on the surface of the touch sensitive display panel.

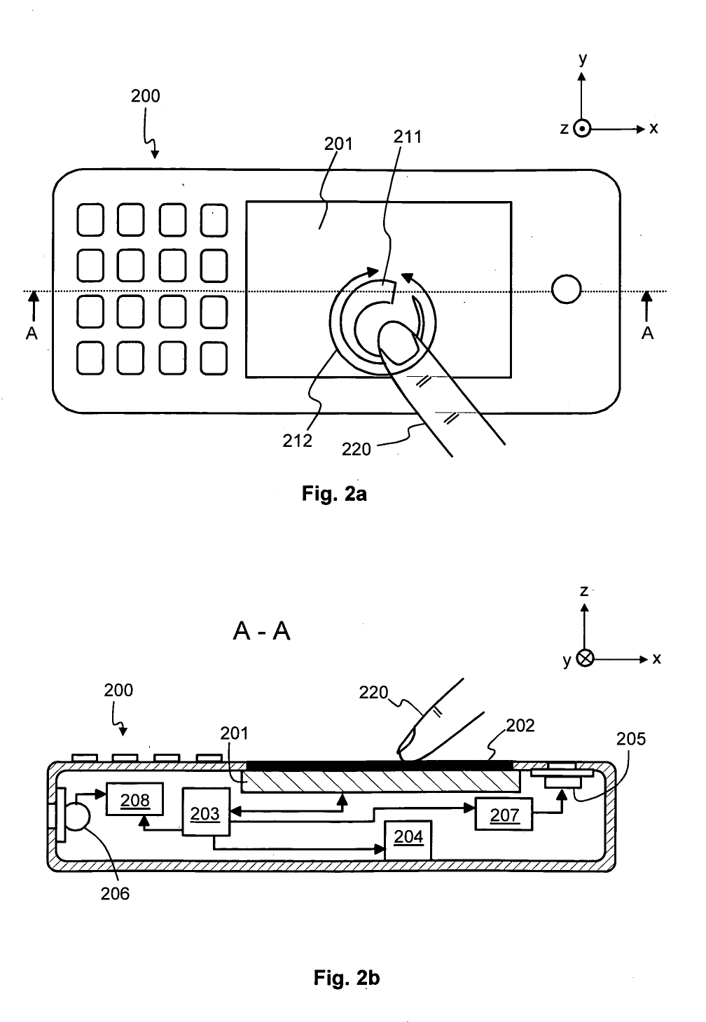

FIG. 2a shows an electronic device 200 according to an embodiment of the invention. FIG. 2b shows the A-A section view of the electronic device. The electronic device can be a mobile communication terminal, a palmtop computer, a portable play station, or a combination of them. The electronic device comprises a touch sensitive display panel 201 and a controller 203 that is arranged to control the electronic device on the basis of a position of an external object 220 on a surface 202 of the touch sensitive display panel 201. The position of the external object can expressed, for example, with the x- and y-coordinates of a spot in which the external object touches the touch sensitive display panel. In the exemplifying situation shown in FIGS. 2a and 2b the external object 220 is a finger of a user of the electronic device 200. The electronic device comprises an actuator 204 that is arranged to generate a signal that is detectable for a human being, i.e. for the user of the electronic device. The actuator is arranged to alter a property of the signal that can be detected by the user as a response to a situation in which the external object 220 is slid on the surface 202 of the touch sensitive display panel. In the exemplifying situation shown in FIGS. 2a and 2b a rotatable control device 211 for controlling a quantity having a continuous nature is implemented with the aid of the touch sensitive display panel 201. The quantity that can be adjusted with the rotatable control device 211 can be, for example, strength of voice generated with a speaker element 205, background brightness of the touch sensitive display panel 201, or amplitude of an electrical signal produced with a microphone 206. The above-mentioned quantity can be increased by sliding the external object along a circular path clockwise according to an arrow 212 on the surface of the touch sensitive display panel. The above-mentioned quantity can be decreased by sliding the external object along the circular path counter-clockwise according to the arrow 212 on the surface of the touch sensitive display panel.

In an electronic device according an embodiment of the invention the actuator 204 is a vibration generator. The controller 203 is arranged to alter amplitude of mechanical vibration produced with the vibration generator as a response to the situation in which the external object is slid on the surface of the touch sensitive display panel. In an electronic device according another embodiment of the invention the controller 203 is arranged to alter frequency of the mechanical vibration produced with the vibration generator as a response to the situation in which the external object is slid on the surface of the touch sensitive display panel.

In an electronic device according an embodiment of the invention the actuator 204 is arranged to alter the property of the signal generated with it as a response to a situation in which the external object is slid along a pre-determined path on the surface of the touch sensitive display panel. The pre-determined path can be a circular path in which case a rotatable control device is implemented with the aid of the touch sensitive display surface as shown in FIG. 2b. As an alternative, the pre-determined path can be a linear path in which case a sliding control device is implemented with the aid of the touch sensitive display surface.

In an electronic device according an embodiment of the invention the controller 203 is arranged to control, on the basis of the position of the external object on the surface of the touch sensitive display panel, a gain of an amplifier circuitry 207 coupled to the speaker element 205.

In an electronic device according an embodiment of the invention the controller 203 is arranged to control, on the basis of the position of the external object on the surface of the touch sensitive display panel, a gain of an amplifier circuitry 208 coupled to the microphone 206.

It should be noted that an electronic device according to an embodiment of the invention is not necessarily a portable electronic device. An electronic device according to an embodiment of the invention can be as well, for example, a domestic appliance or fixed industrial equipment.

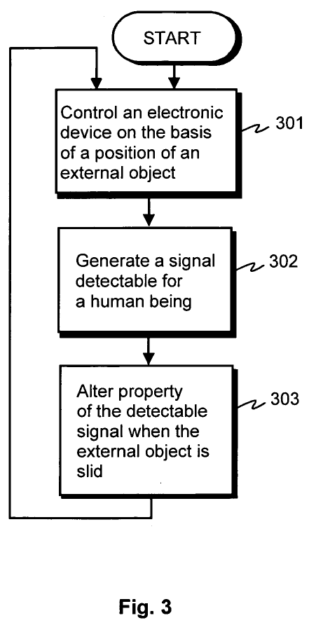

FIG. 3 is a flow chart of a method according to an embodiment of the invention for controlling an electronic device. Phase 301 comprises controlling the electronic device on the basis of a position of an external object on a surface of a touch sensitive display panel. Phase 302 comprises generating a signal that is detectable for a human being. Phase 303 comprises altering a property of said signal as a response to a situation in which the external object is slid on the surface of the touch sensitive display panel. The external object can be e.g. a finger of a user of the electronic device, a pen, or a stylus.

In a method according to an embodiment of the invention the detectable signal is mechanical vibration generated to the housing of the electronic device and amplitude of the mechanical vibration is altered as a response to the situation in which the external object is slid on the surface of the touch sensitive display panel. The mechanical vibration can be generated, for example, with an electromechanical vibration generator or a piezo-electric vibration generator.

In a method according to an embodiment of the invention the detectable signal is mechanical vibration generated to the housing of the electronic device and frequency of said mechanical vibration is altered as a response to the situation in which the external object is slid on the surface of the touch sensitive display panel.

In a method according to an embodiment of the invention the detectable signal is voice and amplitude of the voice is altered as a response to the situation in which the external object is slid on the surface of the touch sensitive display panel.

In a method according to an embodiment of the invention the detectable signal is voice and frequency of the voice is altered as a response to the situation in which the external object is slid on the surface of the touch sensitive display panel.

In a method according to an embodiment of the invention the detectable is light and intensity of the light is altered as a response to the situation in which the external object is slid on the surface of the touch sensitive display.

In a method according to an embodiment of the invention the detectable signal is light and color of the light is altered as a response to the situation in which the external object is slid on the surface of the touch sensitive display.

In a method according to an embodiment of the invention the property of the detectable signal is altered as a response to a situation in which the external object is slid along a pre-determined path on the surface of the touch sensitive display panel. The pre-determined path can be, for example, a linear path on the surface of the touch sensitive display panel or a circular path on the surface of the touch sensitive display panel.

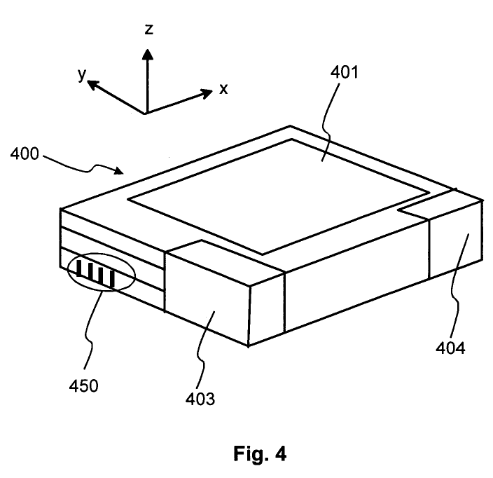

FIG. 4 shows an interface module 400 according to an embodiment of the invention. The interface module can be used as a building block of an electronic device that can be e.g. a mobile phone, a domestic appliance, or industrial equipment. The interface module comprises a touch sensitive display panel 401 and a controller 403 that is capable of controlling an electronic device on the basis of a position of an external object on a surface of the touch sensitive display panel 401. The position of the external object can expressed, for example, with the x- and y-coordinates of a spot in which the external object touches the touch sensitive display panel. The interface module comprises an actuator 404 that is arranged to generate a signal that is detectable for a human being. The actuator is arranged to alter a property of the detectable signal as a response to a situation in which the external object is slid on the surface of the touch sensitive display panel. The interface module comprises connector pads 450 via which electrical signals can be conducted to/from the interface module. The interface module can be used, for example, for implementing a control device with the aid of which a quantity having a continuous nature can be controlled and tactile, audio, and/or visual feedback depending on the type of the actuator 404 can be given to a user of the control device.

In an interface module according to an embodiment of the invention the actuator 404 is arranged to alter the property of the signal generated by it as a response to a situation in which the external object is slid along a pre-determined path on the surface of the touch sensitive display panel. The pre-determined path can be, for example, a linear path on the surface of the touch sensitive display panel or a circular path on the surface of the touch sensitive display panel.

A computer program according to an embodiment of the invention comprises software modules for making a processor unit to control an electronic device that includes:
a touch sensitive display panel, and
an actuator arranged to generate a signal that is detectable for a human being.

The software modules comprise computer executable instructions for making the processor unit:
to control the electronic device on the basis of a position of an external object on a surface of the touch sensitive display panel, and
to alter a property of said signal as a response to a situation in which the external object is slid on the surface of the touch sensitive display panel.

The processor unit in which the computer program can be executed can be e.g. the controller 203 of the electronic device 200 shown in FIGS. 2a and 2b.

The software modules can be, for example, sub-routines and/or functions.

In a computer program according to an embodiment of the invention the computer executable instructions are capable of making the processor unit to alter the property of the detectable signal as a response to a situation in which the external object is slid along a pre-determined path on the surface of the touch sensitive display panel. The pre-determined path can be, for example, a linear path on the surface of the touch sensitive display panel or a circular path on the surface of the touch sensitive display panel.

A computer program according to an embodiment of the invention can be stored in a computer readable medium. The computer readable medium can be, for example, an optical compact disk or an electronic memory device like a RAM (random access memory) or a ROM (read only memory).

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. The specific examples provided in the description given above should not be construed as limiting. Therefore, the invention is not limited merely to the embodiments described above, many variants being possible without departing from the scope of the inventive idea.

1. A user interface comprising:
a touch sensitive display panel,
a controller arranged to control an electronic device on the basis of a position of an external object on a surface of the touch sensitive display panel, and
an actuator arranged to generate a signal that is detectable for a human being,
wherein the actuator is arranged to alter a property of said signal as a response to a situation in which the external object is slid on the surface of the touch sensitive display panel.

2. A user interface according to claim 1, wherein the actuator is a vibration generator that is arranged to alter amplitude of mechanical vibration produced with the vibration generator as a response to the situation in which the external object is slid on the surface of the touch sensitive display panel.

3. A user interface according to claim 1, wherein the actuator is a vibration generator that is arranged to alter frequency of mechanical vibration produced with the vibration generator as a response to the situation in which the external object is slid on the surface of the touch sensitive display panel.

4. A user interface according to claim 1, wherein the actuator is an oscillator that is arranged to alter amplitude of voice produced with the oscillator as a response to the situation in which the external object is slid on the surface of the touch sensitive display panel.

5. A user interface according to claim 1, wherein the actuator is an oscillator that is arranged to alter frequency of voice produced with the oscillator as a response to the situation in which the external object is slid on the surface of the touch sensitive display panel.

6. A user interface according to claim 1, wherein the actuator is a light source that is arranged to alter intensity of light produced with the light source as a response to the situation in which the external object is slid on the surface of the touch sensitive display panel.

7. A user interface according to claim 1, wherein the actuator is a light source that is arranged to alter color of light produced with the light source as a response to the situation in which the external object is slid on the surface of the touch sensitive display panel.

8. A user interface according to claim 1, wherein the actuator is arranged to alter the property of said signal as a response to a situation in which the external object is slid along a pre-determined path on the surface of the touch sensitive display panel.

9. A user interface according to claim 8, wherein the pre-determined path is one of the following: a linear path on the surface of the touch sensitive display panel and a circular path on the surface of the touch sensitive display panel.

10. A user interface according to claim 2, wherein the vibration generator is one of the following: an electromechanical vibration generator and a piezo-electric vibration generator.

11. A method comprising:
controlling an electronic device on the basis of a position of an external object on a surface of a touch sensitive display panel,
generating a signal that is detectable for a human being, and
altering a property of said signal as a response to a situation in which the external object is slid on the surface of the touch sensitive display panel.

12. A method according to claim 11, wherein said signal is mechanical vibration and amplitude of said mechanical vibration is altered as a response to the situation in which the external object is slid on the surface of the touch sensitive display panel.

13. A method according to claim 11, wherein said signal is mechanical vibration and frequency of said mechanical vibration is altered as a response to the situation in which the external object is slid on the surface of the touch sensitive display panel.

14. A method according to claim 11, wherein said signal is voice and amplitude of said voice is altered as a response to the situation in which the external object is slid on the surface of the touch sensitive display panel.

15. A method according to claim 11, wherein said signal is voice and frequency of said voice is altered as a response to the situation in which the external object is slid on the surface of the touch sensitive display panel.

16. A method according to claim 11, wherein said signal is light and intensity of said light is altered as a response to the situation in which the external object is slid on the surface of the touch sensitive display.

17. A method according to claim 11, wherein said signal is light and color of said light is altered as a response to the situation in which the external object is slid on the surface of the touch sensitive display.

18. A method according to claim 11, wherein the property of said signal is altered as a response to a situation in which the external object is slid along a pre-determined path on the surface of the touch sensitive display panel.

19. A method according to claim 11, wherein the pre-determined path is one of the following: a linear path on the surface of the touch sensitive display panel and a circular path on the surface of the touch sensitive display panel.

20. A method according to claim 12, wherein the mechanical vibration is generated with one of the following: an electromechanical vibration generator and a piezo-electric vibration generator.

21. An electronic device comprising:
a touch sensitive display panel,
a controller arranged to control an electronic device on the basis of a position of an external object on a surface of the touch sensitive display panel, and
an actuator arranged to generate a signal that is detectable for a human being,
wherein the actuator is arranged to alter a property of said signal as a response to a situation in which the external object is slid on the surface of the touch sensitive display panel.

22. An electronic device according to claim 21, wherein the actuator is a vibration generator that is arranged to alter amplitude of mechanical vibration produced with the vibration generator as a response to the situation in which the external object is slid on the surface of the touch sensitive display panel.

23. An electronic device according to claim 21, wherein the actuator is a vibration generator that is arranged to alter frequency of mechanical vibration produced with the vibration generator as a response to the situation in which the external object is slid on the surface of the touch sensitive display panel.

24. An electronic device according to claim 21, wherein the actuator is arranged to alter the property of said signal as a response to a situation in which the external object is slid along a pre-determined path on the surface of the touch sensitive display panel.

25. An electronic device according to claim 24, wherein the pre-determined path is one of the following: a linear path on the surface of the touch sensitive display panel and a circular path on the surface of the touch sensitive display panel.

26. An electronic device according to claim 21, wherein the controller is arranged to control a gain of an amplifier circuitry coupled to a speaker element on the basis of the position of the external object on the surface of the touch sensitive display panel.

27. An electronic device according to claim 21, wherein the controller is arranged to control a gain of an amplifier circuitry coupled to a microphone on the basis of the position of the external object on the surface of the touch sensitive display panel.

28. An electronic device according to claim 21, wherein the electronic device is at least one of the following: a mobile communication terminal, a palmtop computer, and a portable play station.

29. A computer readable medium storing a computer program for making a processor unit to control an electronic device that includes:
a touch sensitive display panel, and
an actuator arranged to generate a signal that is detectable for a human being,
the computer program comprising computer executable instructions for making the processor unit:
to control the electronic device on the basis of a position of an external object on a surface of the touch sensitive display panel, and
to alter a property of said signal as a response to a situation in which the external object is slid on the surface of the touch sensitive display panel.

30. A computer readable medium according to claim 29, wherein the computer executable instructions are capable of making the processor unit to alter the property of said signal as a response to a situation in which the external object is slid along a pre-determined path on the surface of the touch sensitive display panel.

31. An interface module comprising:
a touch sensitive display panel,
a controller capable of controlling an electronic device on the basis of a position of an external object on a surface of the touch sensitive display panel, and
an actuator arranged to generate a signal that is detectable for a human being,
wherein the actuator is arranged to alter a property of said signal as a response to a situation in which the external object is slid on the surface of the touch sensitive display panel.

32. An interface module according to claim 31, wherein the actuator is arranged to alter the property of said signal as a response to a situation in which the external object is slid along a pre-determined path on the surface of the touch sensitive display panel.

33. A user interface comprising:
a touch sensitive display panel,
means for controlling an electronic device on the basis of a position of an external object on a surface of the touch sensitive display panel,
means for generating a signal that is detectable for a human being, and
means for altering a property of said signal as a response to a situation in which the external object is slid on the surface of the touch sensitive display panel.
